(19) United States
(12) Patent Application Publication
(10) Pub. No.: US 2018/0188686 A1
(43) Pub. Date: Jul. 5, 2018

(54) METHOD AND APPARATUS FOR HOLOGRAM RESOLUTION TRANSFORMATION

(71) Applicant: ELECTRONICS AND TELECOMMUNICATIONS RESEARCH INSTITUTE, Daejeon (KR)

(72) Inventor: Joong-Ki PARK, Daejeon (KR)

(21) Appl. No.: 15/855,997

(22) Filed: Dec. 27, 2017

(30) Foreign Application Priority Data
Dec. 30, 2016 (KR) 10-2016-0184067
Dec. 19, 2017 (KR) 10-2017-0175554

(51) Int. Cl. G03H 1/08

(52) U.S. Cl. CPC G03H 1/0808; G03H 2226/02; G03H 2001/0825; G03H 1/0866

(57) ABSTRACT

A method and an apparatus for hologram resolution transformation are disclosed. A number of pixels for zero padding for an original hologram of a first resolution is calculated based on a wavelength and an imaging distance, and the zero padding is performed on the original hologram of the first resolution based on the number of pixels to obtain the original hologram of a second resolution. Forward propagation is performed on the original hologram of the second resolution by a reconstruction distance to reconstruct a hologram image.

### CROSS-REFERENCE TO RELATED APPLICATION

This application claims priority to and the benefit of Korean Patent Application Nos. 10-2016-0184067 and 10-2017-0175554 filed in the Korean Intellectual Property Office on Dec. 30, 2016 and Dec. 19, 2017, the entire contents of which are incorporated herein by reference.

### BACKGROUND OF THE INVENTION

### (a) Field of the Invention

The present invention relates to resolution transformation, and more particularly, relates to a method and an apparatus for hologram resolution transformation.

### (b) Description of the Related Art

Digital holograms for digital holographic image services may be directly obtained or may be obtained by numerical computation with a computer generated hologram (CGH).

Specifically, based on 3D scene data obtained by digitalizing with a complementary metal-oxide semiconductor (CMOS) device or a charge coupled device (CCD), or by using a computer generated hologram (CGM) method, a digital hologram image is obtained by expressing all the beams reflected at each surface of the object by a wave equation and calculating interference fringes created by wavefronts through a theoretical wave superposition formula.

A numerical reconstruction procedure of a digital hologram is based either on calculation of a diffraction integral by a Fresnel transform method (FTM) or a convolution method (CM). In the FTM, the size of the pixel of the reconstructed image (which may also be referred to as the reconstruction pixel (RP)) increases with a reconstruction distance or a recording wavelength, and the size of the reconstructed image of the object is reduced for longer distances or longer wavelengths with respect to the number of pixels. In contrast, in the CM, the RP remains the same as the pixel size of the recording array regardless of the reconstruction distance. For numerical reconstruction of digital holograms in paraxial approximation, the CM is suitable for a small reconstruction distance while the FTM is useful for longer distances.

In multi-wavelength digital holography in which the reconstructed images of two holograms of the same object recorded at two different distances are compared by controlling the size of the numerically reconstructed hologram through the FTM, or image size remains constant for each wavelength, a method for converting hologram resolution is required.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and an apparatus for hologram resolution transformation having advantages of being capable of adjusting a hologram image size through resolution transformation using digital holograms with different reconstruction distances or different wavelengths for the same object.

An exemplary embodiment of the present invention provides a method for hologram transformation, including: calculating, by an apparatus, a number of pixels for zero padding for an original hologram of a first resolution based on a wavelength and an imaging distance; performing, by the apparatus, the zero padding on the original hologram of the first resolution based on the number of pixels to obtain the original hologram of a second resolution; and performing, by the apparatus, forward propagation on the original hologram of the second resolution by a reconstruction distance to reconstruct a hologram image.

The calculating of a number of pixels may include: calculating the number of pixels for zero padding based on a wavelength and a reconstruction distance; and calculating a pad size for zero padding based on the calculated number of pixels and a number of pixels of the original hologram of the first resolution.

The performing of the zero padding may include performing the zero padding on the original hologram of the first resolution in an x-axis and a y-axis according to the pad size to obtain the original hologram of the second resolution.

The method may further include: extracting, by the apparatus, an image area from the hologram image; and performing, by the apparatus, backward propagation on the extracted image area in a reverse direction of the reconstruction distance to obtain a backward propagated hologram.

The image area may correspond to the original hologram of the first resolution.

The method may further include: before the calculating of a number of pixels, receiving, by the apparatus, a plurality of holograms with different imaging distances and/or different wavelengths; and calculating, by the apparatus, a reconstruction pixel (RP) which is a size of pixel of a hologram image when the hologram is reconstructed with an imaging distance as a reconstruction distance with respect to each of the plurality of holograms.

The original hologram of the first resolution may be a hologram having a largest RP among holograms for which RPs are calculated.

The calculating of the RP may include calculating the RP using one among a reconstruction distance of the original hologram and a wavelength of the original hologram, or simultaneously using both of the reconstruction distance of the original hologram and the wavelength of the original hologram.

Yet another embodiment of the present invention provides an apparatus for hologram resolution transformation, the apparatus including: an input/output unit configured to receive hologram data; and a processor connected with the input/output unit and configured to perform hologram resolution transformation,

wherein the processor is configured to calculate a number of pixels for an original hologram of a first resolution, perform zero padding on the original hologram of the first resolution based on the number of pixels to obtain the original hologram of a second resolution, and perform forward propagation on the original hologram of the second resolution by a reconstruction distance to reconstruct a hologram image.

The process may be configured to calculate a number of pixels for zero padding based on a wavelength and a reconstruction distance, calculate a pad size for zero padding based on the calculated number of pixels and a number of pixels of the original hologram of the first resolution, and perform the zero padding on the original hologram of the first resolution in an x-axis and a y-axis according to the pad size to obtain the original hologram of the second resolution.

The processor may be configured to further extract an image area from the hologram image and perform backward propagation on the extracted image area in a reverse direction of the reconstruction distance to obtain a backward propagated hologram.

The processor may be further configured to, before calculating the number of pixels, receive a plurality of holograms with different imaging distances and/or different wavelengths and calculate a reconstruction pixel (RP) which is a size of pixels of a hologram image when the hologram is reconstructed with an imaging distance as a reconstruction distance with respect to the plurality of holograms.

The processor may be configured to further select a hologram having a largest RP among holograms for which RPs are calculated as the original hologram of the first resolution.

The processor may be configured to further calculate the RP using one among a reconstruction distance of the original hologram and a wavelength of the original hologram, or simultaneously use both of the reconstruction distance of the original hologram and the wavelength of the original hologram.

The processor may be configured to include: a hologram obtaining unit configured to obtain a plurality of holograms with different imaging distances and/or different wavelengths; an RP calculator configured to calculate RP with respect to each of the plurality of holograms; a pixel calculator configured to calculate a number of pixels for zero padding for the original hologram of the first resolution which is a hologram having a largest RP among holograms for which RPs are calculated and calculate a pad size for zero padding based on the calculated number of pixel; a converter configured to perform the zero padding on the original hologram of the first resolution by the pad size to obtain the original hologram of the second resolution on which the zero padding is performed; and a forward propagation unit configured to perform forward propagation on the original hologram of the second resolution on which the zero padding is performed by a reconstruction distance to reconstruct a hologram image.

The processor may be configured to further include: an extractor configured to extract an image area corresponding to the original hologram of the first resolution from the hologram image; and a backward propagation unit configured to perform backward propagation on an extracted hologram of the extracted image area in a reverse direction of the reconstruction distance. The apparatus may further include a hologram storage unit configured to store the backward propagated hologram.

The processor may be configured to perform forward propagation on the original hologram with a reconstruction distance by using a Fresnel transform method (FTM).

### BRIEF DESCRIPTION OF THE DRAWINGS

FIG. 1 shows an example of a case in which holograms are obtained with different imaging distances for the same object.

FIG. 2 shows an example of a case in which holograms are obtained with the same imaging distance and different wavelengths for the same object.

FIG. 3 shows an example of a case in which holograms are obtained with different imaging distances and different wavelengths for the same object.

FIGS. 4A and 4B show a procedure for obtaining a hologram through numerical reconstruction.

FIG. 5 to FIG. 7 show relationship expressions for maintaining pixel spacing to be the same on a reconstruction plane for each of holograms obtained at different wavelengths and/or different imaging distances of the same object according to an exemplary embodiment of the present invention.

FIG. 8 shows an exemplary embodiment for maintaining pixel spacing to be the same on a reconstruction plane for each of holograms obtained at different wavelengths and different imaging distances of the same object according to an exemplary embodiment of the present invention.

FIGS. 9A to 9C show an example of hologram images to which resolution transformation according to an exemplary embodiment of the present invention is applied.

FIG. 10 shows areas processed in a zero padding procedure according to an exemplary embodiment of the present invention.

FIG. 11 shows a flowchart of a method for hologram resolution transformation according to an exemplary embodiment of the present invention.

FIGS. 12A to 12E show hologram images processed by a method for resolution transformation according to an exemplary embodiment of the present invention.

FIG. 13 shows a configuration diagram of an apparatus for hologram resolution transformation according to an exemplary embodiment of the present invention.

FIG. 14 shows a configuration diagram of an apparatus for hologram resolution transformation according to another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

Hereinafter, a method and an apparatus for hologram resolution transformation according to an exemplary embodiment of the present invention will be described with reference to the accompanying drawings.

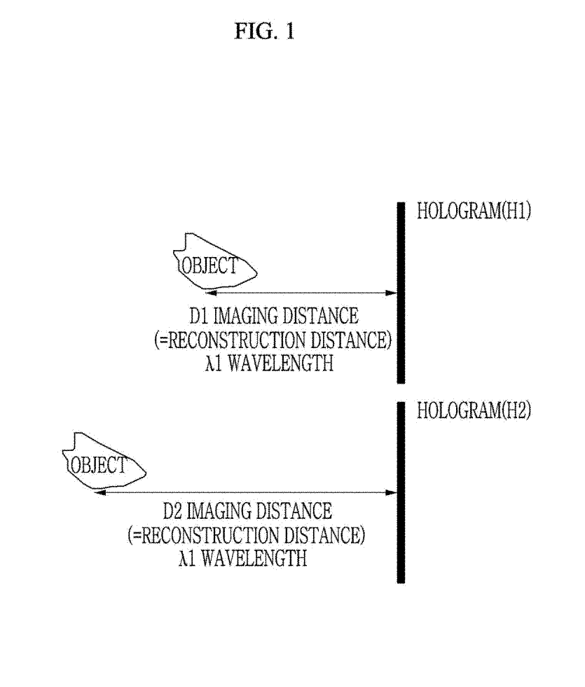

By applying different imaging distances and different wavelengths to the same object, holograms may be obtained as shown in FIG. 1 to FIG. 3.

The hologram is a stereoscopic image formed of a three-dimensional image, and is generated using the principle of holography. The principle of holography is to separate the light beam from a laser into a reference beam that directly illuminates a screen and an object beam that illuminates an object. At this time, since the object beam is reflected from each surface of the object, there is a phase difference depending on the surface of the object. Interference fringes generated by interference of unmodified reference light with the object light are recorded in the screen, and a film in which the interference fringes are stored is referred to as a hologram.

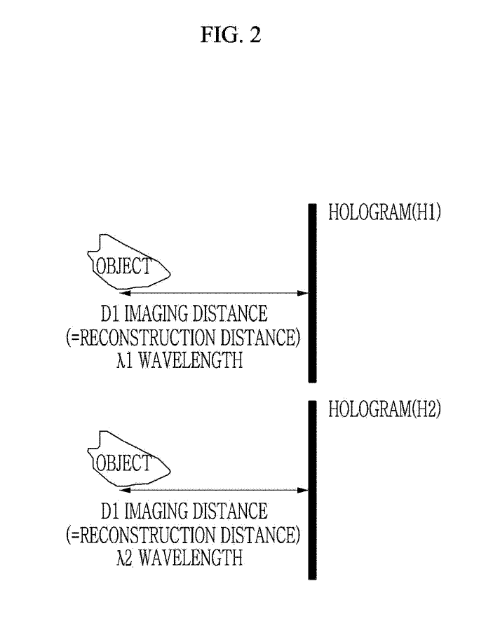

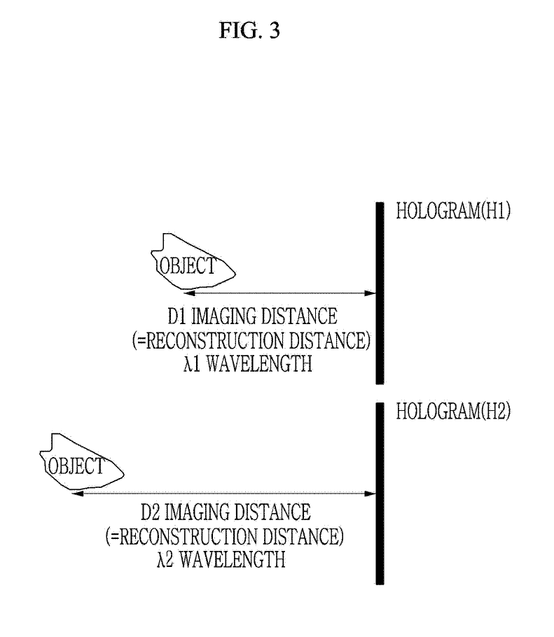

FIG. 1 shows an example of a case in which holograms are obtained with different imaging distances for the same object, FIG. 2 shows an example of a case in which holograms are obtained with the same imaging distance and different wavelengths for the same object, and FIG. 3 shows an example of a case in which holograms are obtained with different imaging distances and different wavelengths for the same object.

For example, as shown in FIG. 1, a hologram H1 is obtained by applying a first imaging distance D1 and a wavelength λ1 to the same object, and a hologram H2 is obtained by applying a second imaging distance D2 and the same wavelength λ1 to the same object.

In addition, as shown in FIG. 2, a hologram H1 is obtained by applying a first imaging distance D1 and a wavelength λ1 to the same object, and a hologram H2 is obtained by applying the same first imaging distance D1 and a different wavelength λ1 to the same object.

Further, as shown in FIG. 3, a hologram H1 is obtained by applying a first imaging distance D1 and a wavelength λ1 to the same object, and a hologram H2 is obtained by applying a second imaging distance D1 and a different wavelength λ2 to the same object.

Holograms of different sizes can be reconstructed by irradiating reference light of different colors with different wavelengths depending on the color of light. Therefore, it is possible to obtain reconstructed images of the same size through resolution transformation from different holograms. In other words, the size of the reconstructed image can be adjusted through resolution transformation for digital holograms obtained using different imaging distances and/or different wavelengths for the same object.

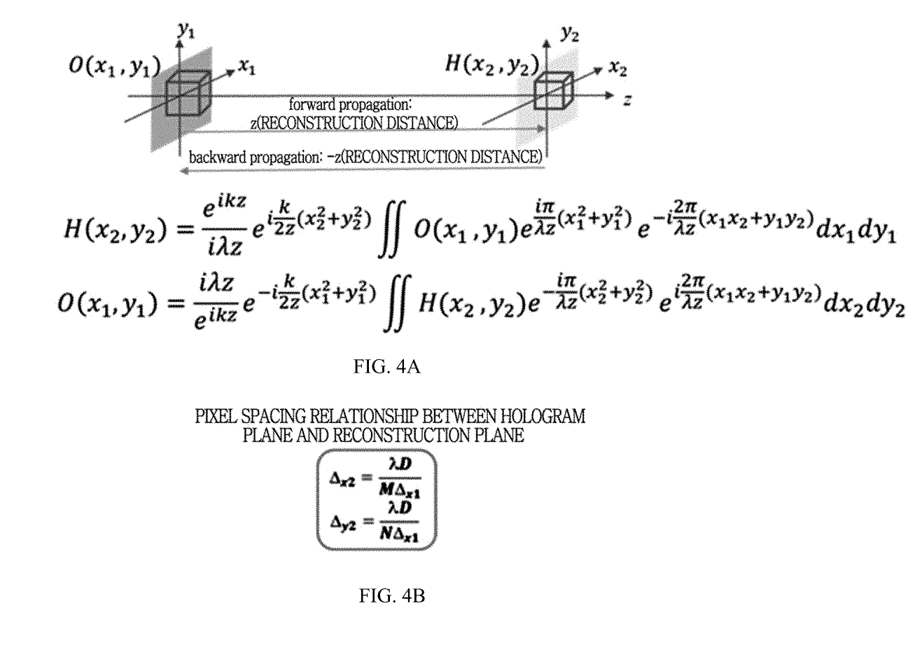

FIGS. 4A to 4B show a procedure for obtaining a hologram through numerical reconstruction.

When a hologram is irradiated with a planar beam as a reference beam, a hologram image is imaged on a reconstruction plane separated from a hologram plane by a reproduction distance z corresponding to the hologram.

For example, when a hologram is numerically reconstructed through the Fresnel transform method (FTM), the coordinate system, pixel spacing, forward propagation, and backward propagation relationships between the hologram plane (x1, y1) and the reconstruction plane (x2, y2) are as shown in the following Equation 1 and in FIGS. 4A to 4B.

$$H ( {x}_{2} , {y}_{2} ) = \frac{{e}^{ikz}}{i λ z} {e}^{i \frac{k}{2 z} ( {x}_{2}^{2} + {y}_{2}^{2} )} \int \int O ( {x}_{1} , {y}_{1} ) {e}^{\frac{i π}{λ z} ( {x}_{1}^{2} + {y}_{1}^{2} )} {e}^{- i \frac{2 π}{λ z} ( {x}_{1} {x}_{2} + {y}_{1} {y}_{2} )} d {x}_{1} d {y}_{1} \\ O ( {x}_{1} , {y}_{1} ) = \frac{ i λ z}{{e}^{ikz}} {e}^{- i \frac{k}{2 z} ( {x}_{1}^{2} + {y}_{1}^{2} )} \int \int H ( {x}_{2} , {y}_{2} ) {e}^{- \frac{i π}{λ z} ( {x}_{2}^{2} + {y}_{2}^{2} )} {e}^{i \frac{2 π}{λ z} ( {x}_{1} {x}_{2} + {y}_{1} {y}_{2} )} d {x}_{2} d {y}_{2} \qquad [ Equation 1 ]$$

The backward propagation means that the hologram image on the reconstruction plane (x2, y2) is made into the hologram on the hologram plane (x1, y1). The forward propagation means that the hologram on the hologram plane (x1, y1) is made into the hologram image on the reconstruction plane (x2, y2) separated by a reproduction distance. Therefore, the backward propagation is a procedure of deriving the hologram on the hologram plane (x1, y1), which produces the hologram image.

In FIG. 4A and Equation 1, O(x₁, y₁) represents a digital hologram (e.g., a digital hologram obtained in any state among the states in FIG. 1 to FIG. 3) that has the amplitude and phase information of an object. Further, H(x₂, y₂) represents an image obtained by reconstructing the hologram O(x₁, y₁) at a reconstruction distance of an imaging distance D. As shown in the pixel spacing relationship

$$( {Δ}_{x 2} = \frac{λ D}{M {Δ}_{x 1}} , {Δ}_{y 2} = \frac{λ D}{N {Δ}_{x 1}} )$$

between the hologram plane (x1, y1) and the reconstruction plane (x2, y2) in FIG. 4B, the pixel spacings Δₓ₂ and Δ_{y2} have a proportional relationship with respect to a wavelength λ and a reconstruction distance D, and have an inverse relationship with respect to the numbers M and N of pixels and the pixel spacings Δₓ₁ and Δ_{y1} of the hologram O(x₁, y₁).

When digital holograms are obtained by differentiating the imaging distance and the wavelength for the same object through numerical reconstruction based on the understanding of the imaging distance and the wavelength and the relationship of the pixel spacing in the numerical reconstruction using the FTM, the image size transformation is performed through the resolution adaptation.

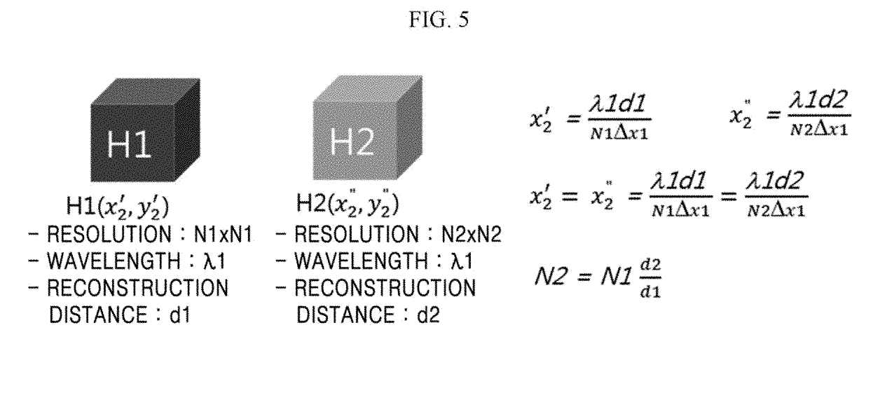

FIG. 5 to FIG. 7 show relationship expressions for maintaining pixel spacing to be the same on a reconstruction plane for each of holograms obtained at different wavelengths and/or different imaging distances of the same object according to an exemplary embodiment of the present invention.

Specifically, FIG. 5 shows a relationship for maintaining the same pixel spacing on a reconstruction plane for a hologram H1 and a hologram H2 having different imaging distances and the same wavelength with respect to the same object.

In order to maintain the same pixel spacing on a reconstruction plane (x2, y2) (may be referred to as an image plane) for a hologram H1 and a hologram H2 having different imaging distances and the same wavelength with respect to the same object, the number N1 of pixels of the hologram image H1 (x2′, y2′) on the reconstruction plane (x2, y2) and the number N2 of pixels of the hologram image H2 (x2″, y2″) on the reconstruction plane (x2, y2) have a relationship of

$$N 2 = N 1 \frac{d 2}{d 1} .$$

In FIG. 5 to FIG. 7, d1 and d2 represent a reconstruction distance when a hologram image is reconstructed by using the imaging distance as a reconstruction distance.

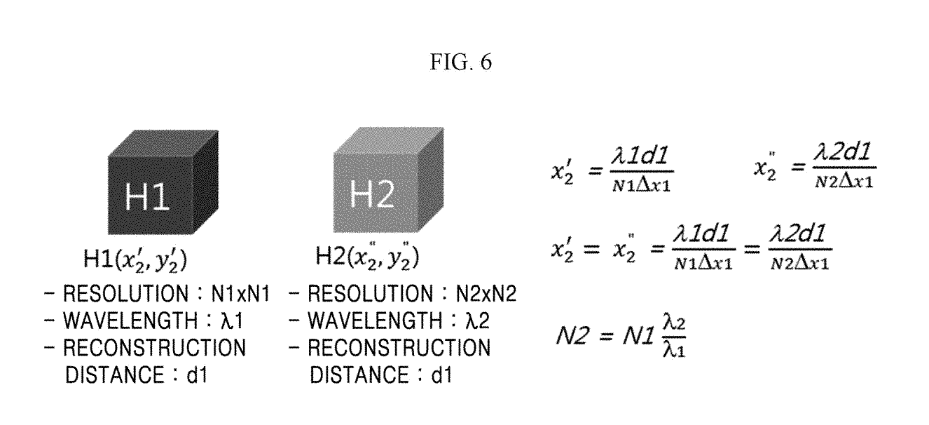

FIG. 6 shows a relationship for maintaining the same pixel spacing on a reconstruction plane for a hologram H1 and a hologram H2 having the same imaging distance and different wavelengths with respect to the same object.

In order to maintain the same pixel spacing on a reconstruction plane (x2, y2) (may be referred to as an image plane) for a hologram H1 and a hologram H2 having the same imaging distance and different wavelengths with respect to the same object, the number N1 of pixels of the hologram image H1 (x2′, y2′) on the reconstruction plane (x2, y2) and the number N2 of pixels of the hologram image H2 (x2″, y2″) on the reconstruction plane (x2, y2) have a relationship of

$$N 2 = N 1 \frac{{λ}_{2}}{{λ}_{1}} .$$

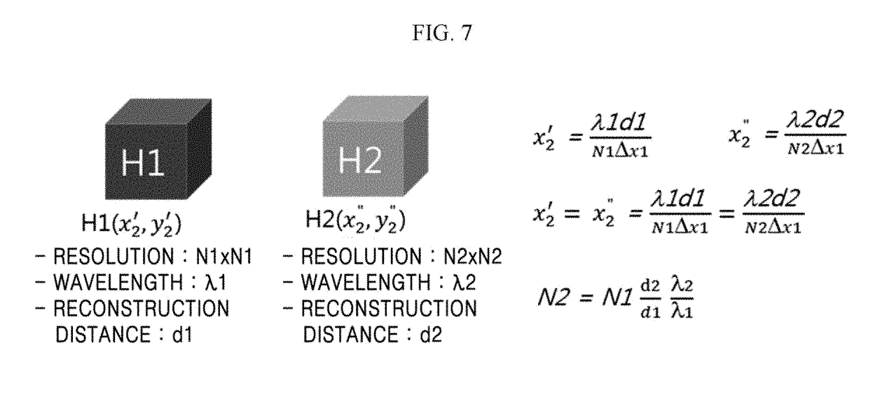

FIG. 7 shows a relationship for maintaining the same pixel spacing on a reconstruction plane for a hologram H1 and a hologram H2 having different imaging distances and different wavelengths with respect to the same object.

In order to maintain the same pixel spacing on a reconstruction plane (x2, y2) (may be referred to as an image plane) for a hologram H1 and a hologram H2 having different imaging distances and different wavelengths with respect to the same object, the number N1 of pixels of the hologram image H1 (x2′, y2′) on the reconstruction plane (x2, y2) and the number N2 of pixels of the hologram image H2 (x2″, y2″) on the reconstruction plane (x2, y2) have a relationship of

$$N 2 = N 1 \frac{d 2}{d 1} \frac{{λ}_{2}}{{λ}_{1}} .$$

Next, a description will be given of how to change the number of pixels on the hologram plane in order to maintain the pixel spacing on the reproduction plane to be the same.

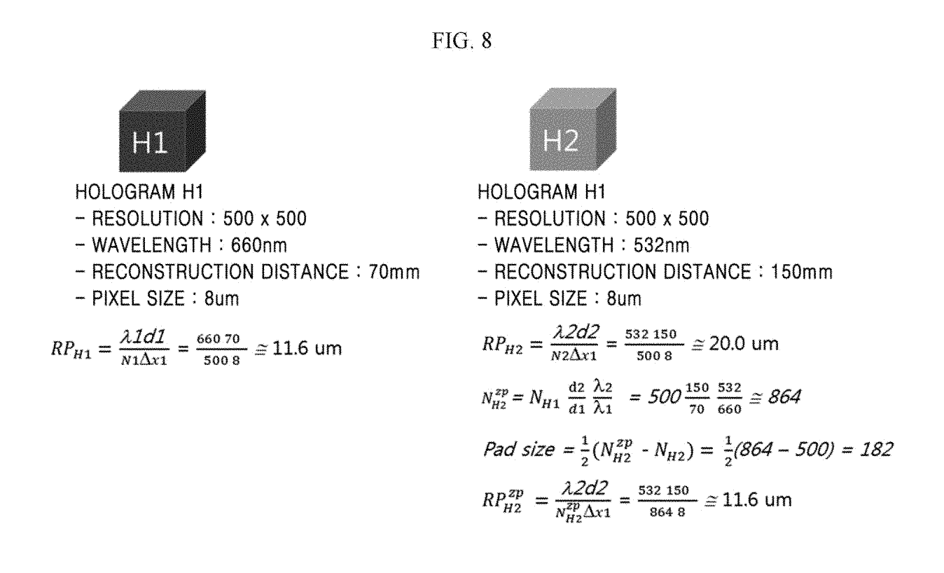

FIG. 8 shows an exemplary embodiment for maintaining pixel spacing to be the same on a reconstruction plane for each of holograms obtained at different wavelengths and different imaging distances of the same object according to an exemplary embodiment of the present invention.

As shown in FIG. 8, when there are a hologram H1 and a hologram H2 obtained with different imaging distances and different wavelengths with respect to the same object, the size of the pixel of the hologram image when the hologram H1 and the hologram H2 are reconstructed with the imaging distances as reconstruction distances is referred to as a reconstruction pixel (RP). The RP (RP_{H1}) for the hologram H1 is approximately 11.6 μm and the RP (RP_{H2}) for the hologram H2 is approximately 20.0 μm.

A zero padding technique is used to make the pixel size on the reconstruction plane (x2, y2) of the hologram H1 and the pixel size on the reconstruction plane (x2, y2) of the hologram H2 equal. Since up-sampling of an image with large pixel spacing can prevent image distortion, zero padding is performed on a hologram of a large RP image. For example, the zero padding may be performed on the hologram having the largest RP among the holograms for which RPs are calculated. Here, the zero padding is performed on the hologram H2 having an RP of 11.6 μm larger than an RP of 20.0 μm.

The number of pixels for zero padding can be derived as follows.

Based on the relationship of

$${N}_{H 2}^{zp} = {N}_{H 1} \frac{d 2}{d 1} \frac{{λ}_{2}}{{λ}_{1}}$$

which adapts the number of pixels of a hologram with respect to a reconstruction distance and a wavelength as shown in FIG. 7, the number N_{H2}^{zp} of pixels for zero padding is calculated by computing the number of pixels in an even number of pixels as shown in FIG. 8, and then “864” is obtained.

Next, the pad size for zero padding is calculated. The pad size is divided into two parts by performing zero padding of the hologram H2 in the negative direction and the positive direction of an x-axis and in the negative direction and the positive direction of a y-axis, respectively. The pad size is calculated based on the equation Pad size=½(N_{H2}^{zp}−N_{H2}). Here, N_{H2} represents the number of pixels of the hologram H2.

Zero padding of 364 pixels is performed in the x-axis and y-axis directions, respectively, by the pad size 182 calculated according to the number of pixels for zero padding with respect to the hologram H2 having the resolution of 500×500. As a result, the resolution of 500×500 of the hologram H2 is converted to the resolution of 864×864. From FIG. 8, it can be seen that the pixel size RP_{H2}^{sp} of the hologram H2 is about 11.6 μm through the zero padding by the pad size, and equals the pixel size of the hologram H1.

Through such processing, the resolution of the image reconstructed on the reconstruction plane is adapted through resolution transformation of the hologram.

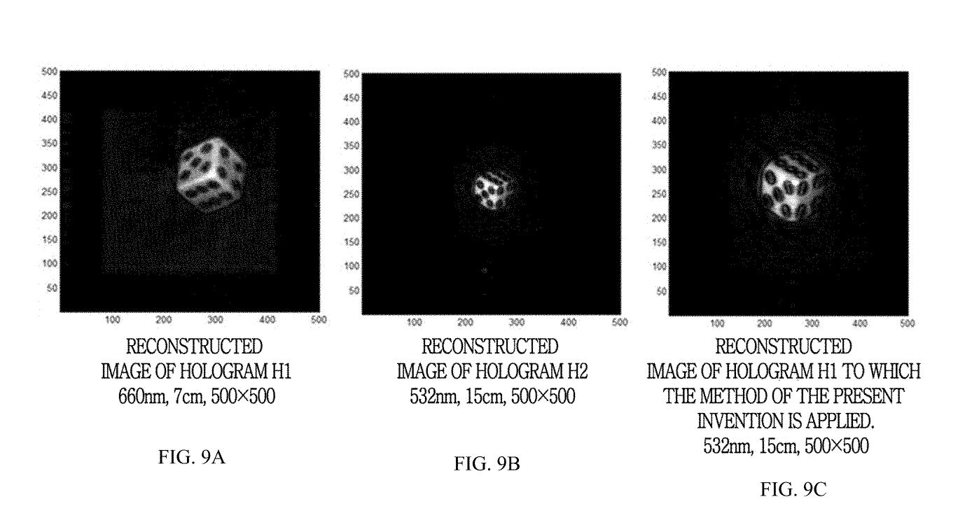

FIGS. 9A to 9C show an example of hologram images to which resolution transformation according to an exemplary embodiment of the present invention is applied.

In FIG. 9A, shows a reconstructed image of the hologram H1, FIG. 9B shows a reconstructed image of the hologram H2, and FIG. 9C shows a reconstructed image of the hologram H2 obtained by applying the method for resolution transformation according to the embodiment of the present invention to the hologram H2, so as to match the size of the reconstructed image of the hologram H2 with the size of the reconstructed image of the hologram H1.

The reproduced image (in FIG. 9C) of the hologram H2 to which the method for resolution transformation according to the embodiment of the present invention is applied shows only a 500×500 region of the original size of the hologram H2 at a resolution of 864×864 through zero padding.

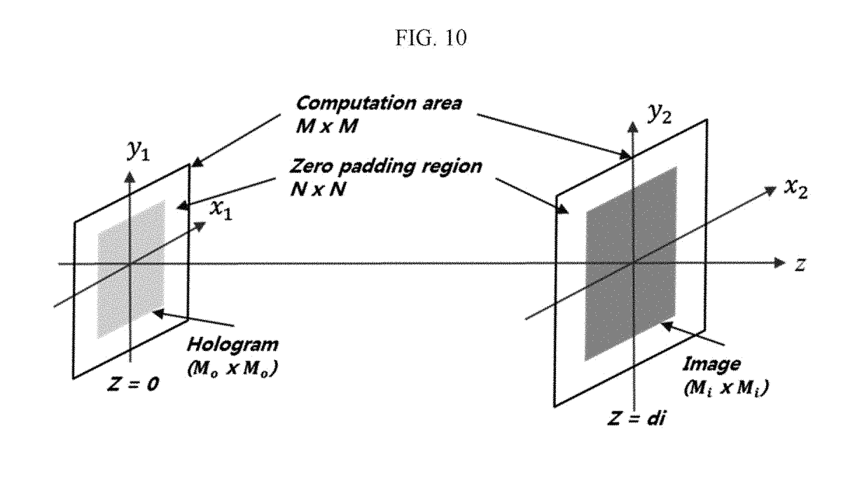

FIG. 10 shows areas processed in a zero padding procedure according to an exemplary embodiment of the present invention.

When adapting the size of a hologram image obtained by performing zero padding on a hologram, a computation area (M×M), a zero padding area (N×N), a hologram area (M₀×M₀), and an image area (Mᵢ×Mᵢ) on the hologram plane (x1, y1) and the reconstruction plane (x2, y2) separated from the hologram plane (x1, y1) by a reconstruction distance di are shown in FIG. 10.

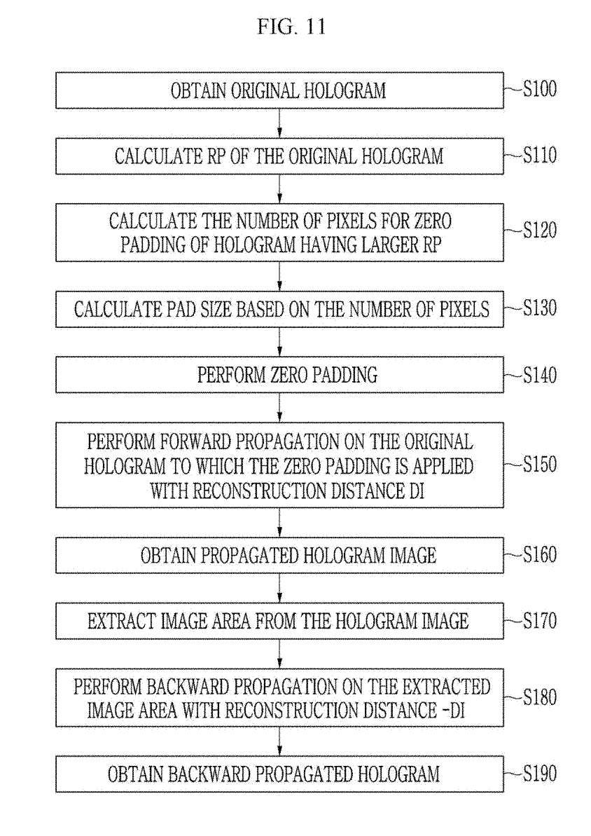

FIG. 11 shows a flowchart of a method for hologram resolution transformation according to an exemplary embodiment of the present invention.

The resolution transformation using the zero padding of the hologram is performed according to an exemplary embodiment of the present invention, and for convenience of explanation, the hologram on which the zero padding is performed will be referred to as an original hologram.

When digital holograms are obtained through numerical reconstruction, in order to perform image size transformation through resolution adaptation, as shown in FIG. 11, a digital original hologram H (x1, y1) is obtained (S100).

The RP of the original hologram H (x1, y1) is calculated (S110).

Then, the number of pixels for zero padding is calculated based on the relationship of wavelengths and reconstruction distances (S120). At this time, the number of pixels for zero padding is calculated with respect to the hologram having the largest RP among a plurality of original holograms. Here, the number of pixels for zero padding is calculated with respect to the original hologram H (x1, y1).

The pad size for zero padding is calculated based on the number of pixels (S130).

According to the calculated pad size, zero padding is performed on the x-axis and y-axis of the hologram H (x1, y1), respectively (S140). Thus, the original hologram H_{(x1, y1)}^{zp} to which the zero padding is applied is obtained.

The original hologram H_{(x1, y1)}^{zp} to which the zero padding is applied is propagated with a reconstruction distance di (forward propagation) by using the FTM (S150). That is, the original hologram H_{(x1, y1)}^{zp} to which the zero padding is applied is made into a hologram image on the reconstruction plane (x2, y2) separated by the reconstruction distance di. Accordingly, a reconstructed hologram image H_{(x2, y2)}^{zp} of the original hologram H_{(x1, y1)}^{zp} to which the zero padding is applied is obtained (S160).

Meanwhile, a hologram may be obtained by performing backward propagation on the hologram image H_{(x2, y2)}^{zp} of which the size is adapted through resolution transformation as above.

Specifically, an image area H_{(x2, y2)}^{crop} is extracted from the hologram image H_{(x2, y2)}^{zp} (S170). The extracted image area H_{(x2, y2)}^{crop} is backward propagated with a reconstruction distance −di by using the FTM (S180). Thus, the backward propagated hologram H_{(x2, y2)}^{back} is obtained. The obtained hologram may be stored and managed (S190).

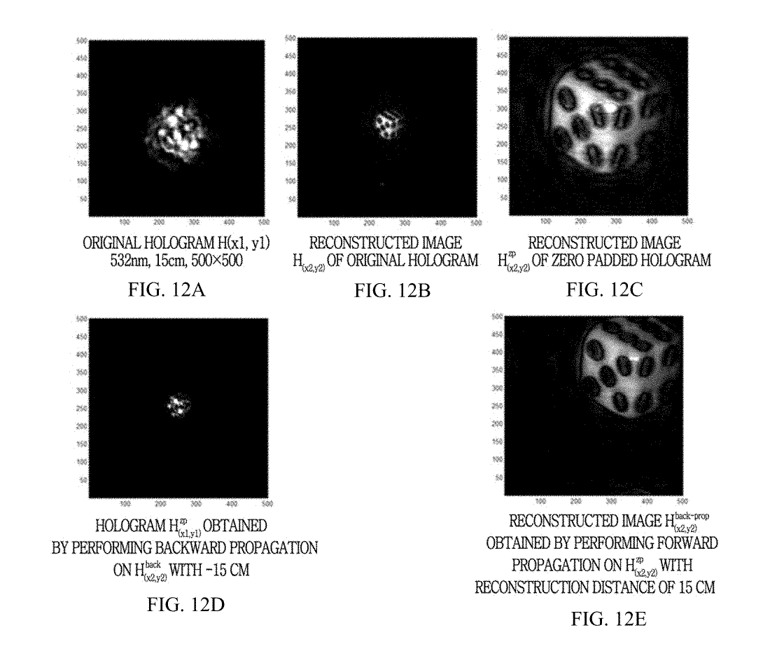

FIGS. 12A to 12E show hologram images processed by a method for resolution transformation according to an exemplary embodiment of the present invention.

For example, when the original hologram H (x1, y1) as shown in FIG. 12A is propagated with the reconstruction distance of 15 cm without performing zero padding, the hologram image as shown in FIG. 12B is reconstructed. When the zero padding on the original hologram H (x1, y1) as shown in FIG. 12A is performed and then the original hologram H (x1, y1) is propagated with the reconstruction distance of 15 cm, the hologram image as shown in FIG. 12C is reconstructed.

The backward propagated hologram as shown in FIG. 12D may be obtained by performing backward propagation on the image area extracted from the hologram image. In addition, when the backward propagated hologram is backward propagated with the reconstruction distance of 15 cm, the hologram image as shown in FIG. 12B is reconstructed. Further, when the hologram is propagated with the reconstruction distance of 15 cm, the hologram image H_{(x2, y2)}^{back-prop} as shown in FIG. 12E is reconstructed.

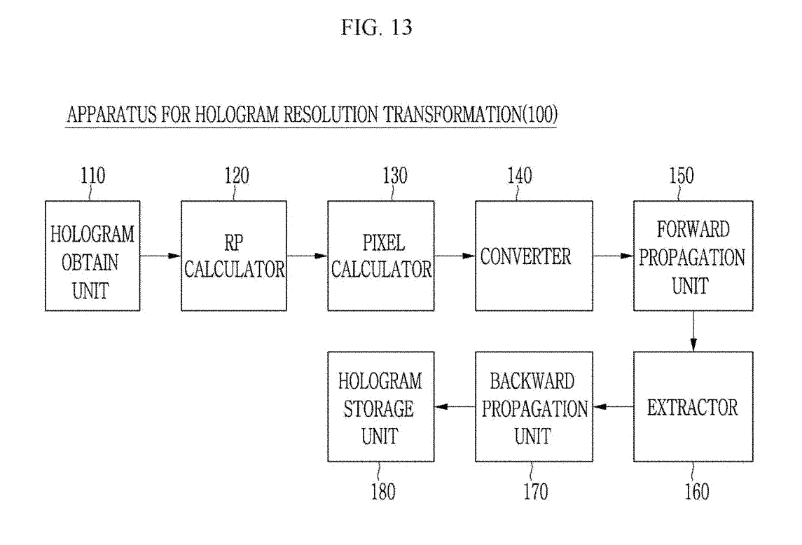

FIG. 13 shows a configuration diagram of an apparatus for hologram resolution transformation according to an exemplary embodiment of the present invention.

The apparatus 100 for hologram resolution transformation according to an exemplary embodiment of the present invention includes, as shown in FIG. 13, a hologram obtain unit 110, an RP calculator 120, a pixel calculator 130, a converter 140, and a forward propagation unit 150, and further includes an extractor 160, a backward propagation unit 170 and a hologram storage unit 180.

The hologram obtaining unit 110 is configured to read and obtain original digital holograms. For convenience of explanation, the original digital hologram will be referred to as an original hologram.

The RP calculator 120 is configured to calculate the RP with the original hologram.

The pixel calculator 130 is configured to calculate the number of pixels for zero padding based on the relationship of wavelengths and imaging distances (reconstruction distances), and to calculate the pad size for zero padding based on the number of pixels. At this time, the number of pixels and the pad size for zero padding are calculated with respect to the hologram having the largest RP among a plurality of original holograms.

The converter 140 is configured to perform zero padding on the original hologram by the pad size according to the number of pixels to generate the hologram on which the zero padding is performed.

The forward propagation unit 150 is configured to perform forward propagation on the hologram on which the zero padding is performed with a reconstruction distance by using the FTM, so as to reconstruct a hologram image.

The extractor 160 is configured to extract an image area (the area of the original hologram) from the propagated hologram of the zero padded hologram, that is, the hologram image.

The backward propagation unit 170 is configured to perform backward propagation on the extracted image area, that is, the extracted hologram, in the reverse direction of the reconstruction distance.

The hologram storage unit 180 is configured to store the backward propagated hologram.

Meanwhile, the apparatus for hologram resolution transformation according to the embodiment of the present invention may further include an encoding unit (not shown) for encoding the zero padded hologram according to a holographic display type. The holographic display type includes amplitude modulation, phase modulation, and the like.

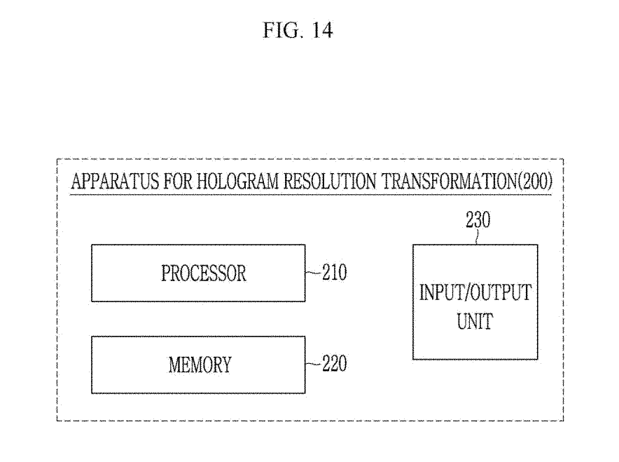

FIG. 14 shows a configuration diagram of an apparatus for hologram resolution transformation according to another exemplary embodiment of the present invention.

As shown in FIG. 14, the apparatus 200 for hologram resolution transformation according to another exemplary embodiment of the present invention includes a processor 210, a memory 220, and an input/output unit 230. The processor 210 may be configured to implement the methods described with reference to FIGS. 1 to 12A-12E. For example, the processor 210 may be configured to perform functions of the hologram obtaining unit, the RP calculator, the pixel calculator, the converter, the forward propagation unit, the extractor 160, and the backward propagation unit.

The memory 220 is connected to the processor 210, and stores various information related to the operations of the processor 210. The memory 220 may store instructions for operations to be performed by the processor 210, or load the instructions from a storage device (not shown) and temporarily store the loaded instructions. Further, the memory 220 may be configured to perform functions of, for example, the hologram storage unit.

The processor 210 may execute the instructions which are stored or loaded in the memory 220. The processor 210 and the memory 220 are connected to each other through a bus (not shown), and the bus may also be connected to an input/output interface (not shown).

The input and output unit 230 is configured to output a processing result of the processor 210 or to input any data (digital holograms) to the processor 110.

The apparatus for hologram resolution transformation according to the embodiment of the present invention can be implemented in the form of being included in the hologram transformation apparatus between the hologram acquisition apparatus and the reproduction apparatus when realizing a hologram broadcasting service.

According to an exemplary embodiment of the present invention, the hologram image size can be adjusted through the resolution transformation independently of the reconstruction distance and the wavelength using raw hologram data.

Particularly, when the color hologram is acquired and restored, the image size of the same object varies according to the wavelength. Therefore, it is not necessary to photograph the same object at different imaging distances for each wavelength at the time of acquisition. In addition, when the color hologram is reproduced at the same reproduction distance, the image size of the hologram can be varied for each wavelength, so that it is possible to eliminate the inconvenience of color matching of the color hologram.

The exemplary embodiments of the present invention are not implemented only by the apparatus and method described above. Alternatively, the exemplary embodiments may also be implemented by a program for performing functions which correspond to the configuration of the exemplary embodiments of the present invention, a recording medium on which the program is recorded, and the like. These implementations may be easily devised from the description of the exemplary embodiments by those skilled in the art to which the present invention pertains. While the exemplary embodiments of the present invention have been described in detail, it is to be understood that the invention is not limited to the disclosed embodiments, but on the contrary, is intended to cover various modifications and equivalent arrangements included within the spirit and scope of the appended claims.

What is claimed is:

1. A method for hologram transformation, comprising:
calculating, by an apparatus, a number of pixels for zero padding for an original hologram of a first resolution based on a wavelength and an imaging distance;
performing, by the apparatus, the zero padding on the original hologram of the first resolution based on the number of pixels to obtain the original hologram of a second resolution; and
performing, by the apparatus, forward propagation on the original hologram of the second resolution by a reconstruction distance to reconstruct a hologram image.

2. The method of claim 1, wherein the calculating of a number of pixels comprises:
calculating the number of pixels for zero padding based on a wavelength and a reconstruction distance; and
calculating a pad size for zero padding based on the calculated number of pixels and a number of pixels of the original hologram of the first resolution.

3. The method of claim 2, wherein the performing of the zero padding comprises performing the zero padding on the original hologram of the first resolution in an x-axis and a y-axis according to the pad size to obtain the original hologram of the second resolution.

4. The method of claim 1, further comprising:
extracting, by the apparatus, an image area from the hologram image; and
performing, by the apparatus, backward propagation on the extracted image area in a reverse direction of the reconstruction distance to obtain a backward propagated hologram.

5. The method of claim 4, wherein the image area corresponds to the original hologram of the first resolution.

6. The method of claim 1, wherein further comprising:
before the calculating of a number of pixels,
receiving, by the apparatus, a plurality of holograms with different imaging distances and/or different wavelengths; and
calculating, by the apparatus, a reconstruction pixel (RP) which is a size of pixels of a hologram image when the hologram is reconstructed with an imaging distance as a reconstruction distance with respect to each of the plurality of holograms.

7. The method of claim 6, wherein the original hologram of the first resolution is a hologram having a largest RP among holograms for which RPs are calculated.

8. The method of claim 6, wherein the calculating of the RP comprises calculating the RP using one among a reconstruction distance of the original hologram and a wavelength of the original hologram, or simultaneously using both of the reconstruction distance of the original hologram and the wavelength of the original hologram.

9. An apparatus for hologram resolution transformation, comprising:
an input/output unit configured to receive hologram data; and
a processor connected with the input/output unit and configured to perform hologram resolution transformation,
wherein the processor is configured to calculate a number of pixels for an original hologram of a first resolution, perform zero padding on the original hologram of the first resolution based on the number of pixels to obtain the original hologram of a second resolution, and perform forward propagation on the original hologram of the second resolution by a reconstruction distance to reconstruct a hologram image.

10. The apparatus of claim 9, wherein the process is configured to calculate a number of pixels for zero padding based on a wavelength and a reconstruction distance, calculate a pad size for zero padding based on the calculated number of pixels and a number of pixels of the original hologram of the first resolution, and perform the zero padding on the original hologram of the first resolution in an x-axis and a y-axis according to the pad size to obtain the original hologram of the second resolution.

11. The apparatus of claim 9, wherein the processor is configured to further extract an image area from the hologram image and perform backward propagation on the extracted image area in a reverse direction of the reconstruction distance to obtain a backward propagated hologram.

12. The apparatus of claim 9, wherein the processor is configured to, before calculating the number of pixels, further receive a plurality of holograms with different imaging distances and/or different wavelength and calculate a reconstruction pixel (RP) which is a size of pixels of a hologram image when the hologram is reconstructed with a imaging distance as a reconstruction distance with respect to the plurality of holograms.

13. The apparatus of claim 12, wherein the processor is configured to further select a hologram having a largest RP among holograms for which RPs are calculated as the original hologram of the first resolution.

14. The apparatus of claim 12, wherein the processor is configured to further calculate the RP using one among a reconstruction distance of the original hologram and a wavelength of the original hologram, or simultaneously using both of the reconstruction distance of the original hologram and the wavelength of the original hologram.

15. The apparatus of claim 9, wherein the processor is configured to comprise:
a hologram obtaining unit configured to obtain a plurality of holograms with different imaging distances and/or different wavelengths;
an RP calculator configured to calculate RP with respect to each of the plurality of holograms;
a pixel calculator configured to calculate a number of pixels for zero padding for the original hologram of the first resolution which is a hologram having a largest RP among holograms for which RPs are calculated and calculate a pad size for zero padding based on the calculated number of pixels;
a converter configured to perform the zero padding on the original hologram of the first resolution by the pad size to obtain the original hologram of the second resolution on which the zero padding is performed; and
a forward propagation unit configured to perform forward propagation on the original hologram of the second resolution on which the zero padding is performed by a reconstruction distance to reconstruct a hologram image.

16. The apparatus of claim 15, wherein the processor is configured to further comprise:
an extractor configured to extract an image area corresponding to the original hologram of the first resolution from the hologram image; and
a backward propagation unit configured to perform backward propagation on an extracted hologram of the extracted image area in a reverse direction of the reconstruction distance,
wherein the apparatus further comprises a hologram storage unit configured to store the backward propagated hologram.

17. The apparatus of claim 9, wherein the processor is configured to perform forward propagation on the original hologram with a reconstruction distance by using a Fresnel transform method (FTM).
